(19) United States
(12) Patent Application Publication
(10) Pub. No.: US 2004/0204972 A1
(43) Pub. Date: Oct. 14, 2004

(54) Software tool for evaluating the efficacy of investments in software verification and validation activities and risk assessment

(76) Inventors: Animesh Anant, Bloomingdale, IL (US); Jongmoon Baik, Hoffman Estates, IL (US); Nancy S. Eickelmann, Schaumburg, IL (US); Sang H. Hyun, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/413,095

(22) Filed: Apr. 14, 2003

(51) Int. Cl. G06F 17/60

(52) U.S. Cl. 705/7

(57) ABSTRACT

A system including software is provided for assessing the consequences of failure, likelihood of failure, and overall risk associated with software to be developed by a software development project, and for assessing the efficacy of potential investments in software verification and validation activities. The system bases the assessment of risk on user input as to the consequences of failure, and the characteristics of the software development team. The efficacy of investments in verification and validation is based on a model of the costs of propagation of errors between phases of a software development project, the scope of investments, the maturity of the software development organization, and other factors.

### FIELD OF THE INVENTION

The present invention relates in general to financial software tools. More particularly, the present invention relates to tools for assessing risk and predicting the value of verification and validation activities in software development.

### BACKGROUND OF THE INVENTION

During the information age the scale of software development projects has greatly increased. Typical software development projects have changed from small projects that involved typically one lone programmer, or a small group of collaborators into large-scale endeavors that may in some cases utilize tens or even hundreds of programmers. The size of software applications has also grown commensurately. Whereas, a decade and a half ago software applications often included less than 10,000 lines of code, and required less than 100 Kilobytes storage, today's applications typically include 1 million lines of code and require over one megabyte of storage. Large complex development projects are managed using modern project management methods. Accordingly, these development projects are divided into several phases. As the size and complexity of software development projects has increased the opportunities for errors to occur at various phases of development has also increased. If such errors are not caught in the phase of development in which they occur, and are propagated into later phases of development, the cost or correcting the errors will increase exponentially. If errors that occur during software development are not caught before the software is released, negative consequence of various degrees can result.

In order to improve the quality of software and reduce the costs associated with poor quality software (e.g., rework costs, loss of goodwill), various methods of software verification and validation have been developed. Such verification and validation methods can be applied at each phase of software development projects; however, there is a cost to do so. More experienced and mature software development groups tend to make fewer errors in software development, so for such groups the cost of applying verification and validation methods at one or more phases may exceed the cost associated with any errors that such methods might catch. In such cases, and in other cases, it is often difficult to judge what amount of verification and validation is justified economically. It would be desirable to have a software tool for assessing the risk associated with software development projects and assisting in the planning of investments in verification and validation to be applied to software development projects.

### BRIEF DESCRIPTION OF THE FIGURES

The present invention will be described by way of exemplary embodiments, but not limitations, illustrated in the accompanying drawings in which like references denote similar elements, and in which:

FIG. 1 is a first part of a first flow chart of a first part of a software tool for assessing the risk related to a software development project;

FIG. 2 is a first screen shot of a graphical user interface of the software tool;

FIG. 3 is a second part of the first flow chart of the software tool;

FIG. 4 is a third part of the first flow chart of the software tool;

FIG. 5 is a fourth part of the first flow chart of the software tool;

FIG. 6 is a fifth part of the first flow chart of the software tool;

FIG. 7 is a second screen shot of the graphical user interface of the software tool;

FIG. 8 is a sixth part of the first flow chart of the software tool;

FIG. 9 is a chart illustrating the dependence of overall software project risk, on the likelihood of failure and the consequences of failure;

FIG. 10 is a first part of a second flow chart of the software tool for assessing the efficacy of investing in software verification and validation technologies at various phases of a development project;

FIG. 11 is a graph representation of the Knox model of the cost of software quality;

FIG. 12 is a second part of the second flow chart;

FIG. 13 is a third part of the second flow chart;

FIG. 14 is third screen shot of the graphical user interface;

FIG. 15 is a fourth screens shot of the graphical user interface; and

FIG. 16 is a block diagram of a computer 1500 used to execute the algorithms shown in FIGS. 1, 3-6, 8, 10, 12, 13.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

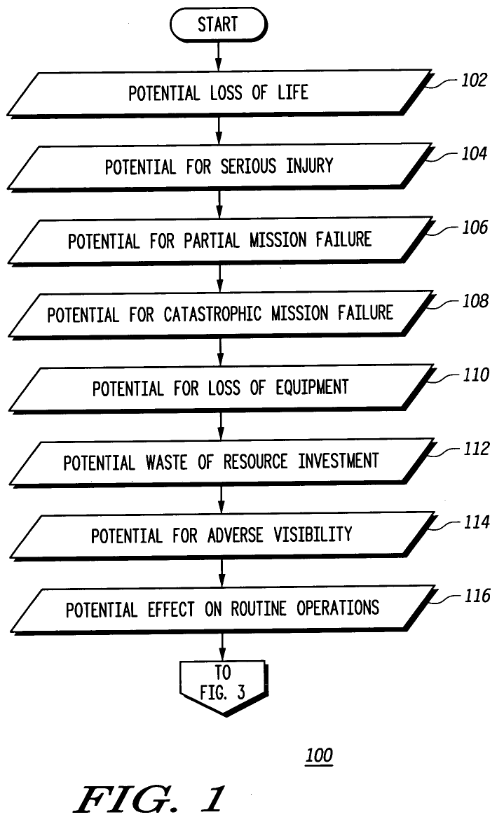

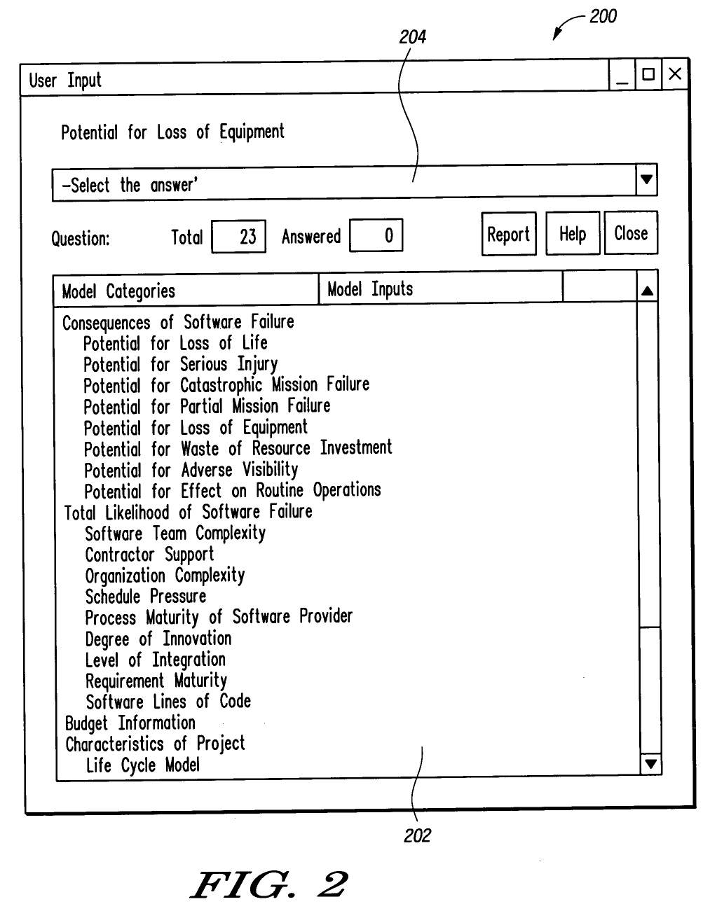

FIG. 1 is a first part of a first flow chart 100 of a first part of a software tool for assessing the risk related to a software development project. FIG. 1 includes a sequence of data input blocks 102-116 for reading in data that is used to categorize the consequences of software failure. The data input in blocks 102-116 is preferably input through the graphical user interface (GUI) 200 shown in FIGS. 2, 7, 14 and described more fully below. In block 102 user input as to whether there is a potential for loss of life if software to be developed by the software development project fails is read in. In block 104 user input as to whether there is potential for serious injury is read in. In block 106 user input as to whether failure of the software could potentially lead to partial mission failure is read in. In 108 user input as to whether failure of the software could lead to catastrophic mission failure is read in. User input read in block 102-108 preferably takes the form of yes/no answers. In block 110 user input as to which of several ranges characterizes the cost of equipment that could potentially be lost due to failure of the software to be developed is read in. In block 112 user input as to which of several ranges characterizes the potential waste of resources, in terms of staff years that would be in jeopardy if the software to be developed fails is read in. In block 114 user input as to the potential for adverse visibility is read in. User input as to the potential for adverse visibility preferably takes the form of a selection of one of several possible scopes of adverse visibility (e.g., facility wide, within agency, national, international). In block 116 user input as to the potential effect on routine operations is read in. User input as to the potential effect on routine operations preferably takes the form of selection of one scope from a plurality of scopes of effect (e.g., agency wide work stoppage, center work stoppage, agency wide inconvenience).

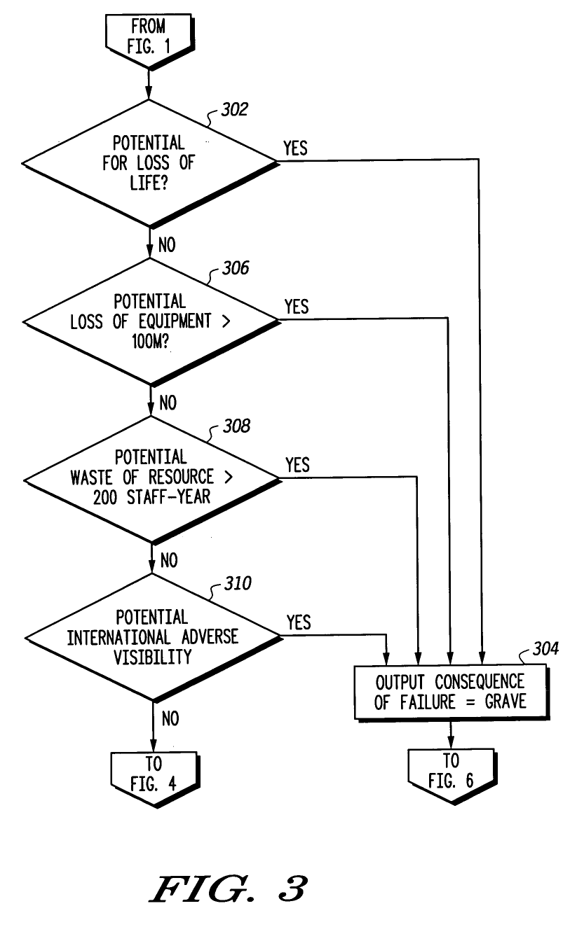

FIG. 2 is a first screen shot of a graphical user interface 200 of the software tool. The user interface comprises a selection window 202 that is used to select a type of data to be input. A user would use a pointing device (e.g., a mouse) to select the type of data that the user would like to supply. Above the selection window 202, is a drop down select list 204. In response to the user selecting a type of data in the selection window, the drop down select list 204 is modified to contain a set of possible answers appropriate to the selected type of data. The user then selects data to be input from the drop down select list 204. As shown in FIG. 2, “Potential Loss of Equipment” is highlighted in the selection window 202. As an example, the options presented in the drop down select list 204 for “Potential Loss of Equipment” can include greater than 100 million, 20 to 100 million, 2 to 20 million, and less than 2 million. For certain other selected types of data, the drop down select list 204 includes only yes and no. Other options to appear in the drop down select list 204 will be evident from the discussion of FIGS. 3-5 that follows. FIGS. 3-5 show second, third, and fourth parts of the first flow chart that are used to categorize the consequences of failure of the software being developed, based on data input by the user according to FIG. 1, using the GUI 200 shown in FIG. 2. According to an alternative mode of using the tool, the user can select a consequence of failure category in the drop down select text box, and by pass the blocks of FIGS. 1, 3-5.

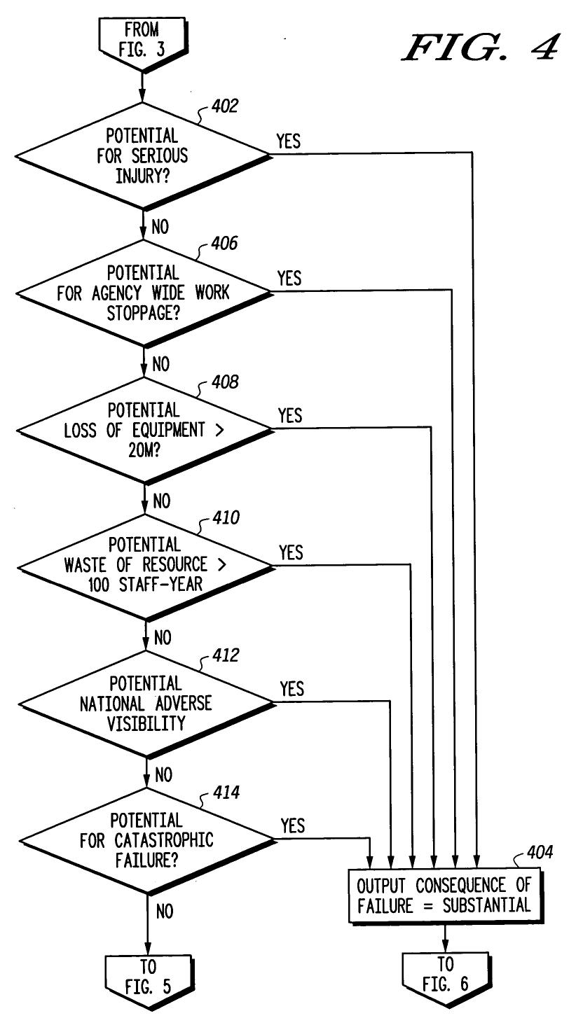

FIG. 3 includes several tests based on the user input provided in FIG. 1 that determine if the consequences of failure should be categorized as grave. After block 116 in FIG. 1, the flow chart 100 continues with block 302 of FIG. 3. Referring to FIG. 3, block 302 is a decision block the outcome of which depends on whether there is a potential for loss of life if the software to be developed fails. If so, then the flow chart branches to block 304 in which the consequence of failure is set to grave and an indication thereof is output to the user through GUI 202. If on the other hand there is no potential for loss of life, then the software tool continues with decision block 306, the outcome of which depends on whether there is a potential loss of equipment greater than 100 million dollars. Note that the specific figures used in the flow charts are merely exemplary, and are alternatively set to values other than those shown, at the discretion of an implementer of the software tool. Monetary amounts are to be given in a currency corresponding to the nationality of the user. If it is determined in block 306 that there is a potential loss of equipment greater than 100 million dollars then the software tool branches to block 304 in which the consequence of failure is set to grave. If on the other hand it is determined in block 306 that there is not a potential loss of equipment greater than 100 million dollars, then the software tool continues with decision block 308, the outcome of which depends on whether there is potential for waste of human resources in excess of 200 staff-years. If it is determined in block 308 that there is a potential for waste of human resources in excess of 200 staff years then the software tool branches to block 304 in which the consequence of failure is set to grave. If on the other hand it is determined in block 308 that there is not a potential for waste of human resources in excess of 200 staff years, then the software tool continues with decision block 310 the outcome of which depends on whether there is potential for international adverse visibility in the event that the software being developed fails. If it is determined in block 310 that there is a potential for international adverse publicity then the software tool branches to block 304 in which the consequence of failure is set to grave. If on the other hand it is determined in block 310 that there is no potential for adverse visibility then it is concluded that the consequence of failure of the software to be developed is not grave, and the software tool continues as shown in FIG. 4 et seq. to categorize the consequences of failure.

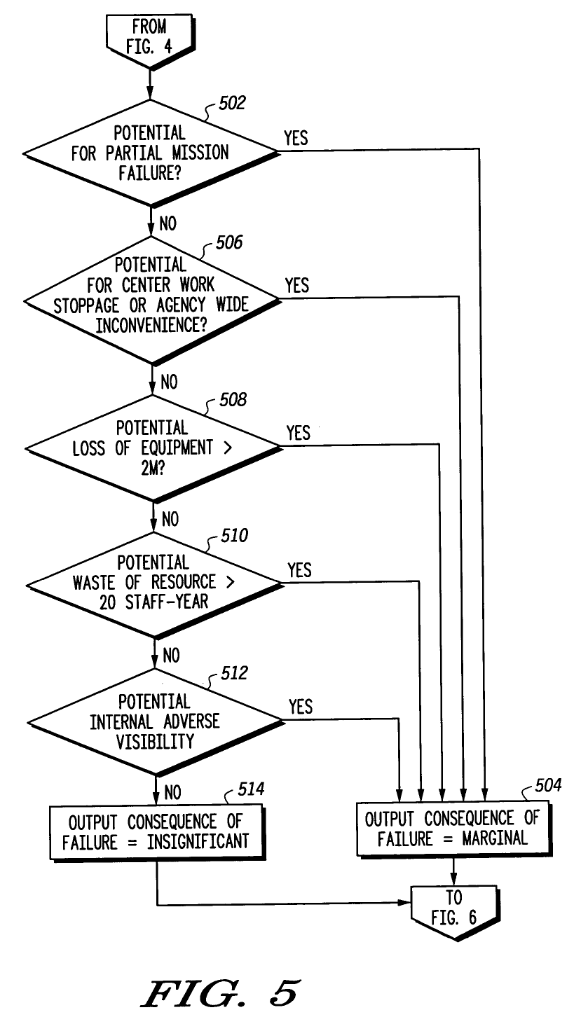

FIG. 4 includes several tests based on the user input provided in FIG. 1 that determine if the consequences of failure should be categorized as substantial. Referring to FIG. 4 decision block 402 follows decision block 310, in the case that the outcome of block 310 is negative as to the potential for international adverse visibility. The outcome of decision block 402 depends on whether there is a potential for serious injury. If it is determined in block 402, based on user input in block 104, that there is a potential for serious injury the software tool branches to block 404 in which the consequence of failure is set to substantial and an indication thereof output to the user. If on the other hand it is determined in block 402 that there is no potential for serious injury then the software tool continues with decision block 406 the outcome of which depends on whether there is a potential for an agency wide work stoppage in the event that the software being developed fails. If it is determined in block 406 that there is a potential for an agency wide work stoppage, then the software tool branches to block 404 in which the consequence of failure is set to substantial. If on the other hand it is determined that there is not a potential for an agency wide work stoppage then the software tool continues with decision block 408, the outcome of which depends on whether there is a potential for loss of equipment in excess of 20 million dollars in the event of software failure. If it is determined in decision block 408 that there is a potential for equipment loss in excess of 20 million dollars then the software tool branches to block 404 in which the consequence of failure is set to substantial. If on the other hand it is determined in block 408 that there is not a potential for equipment loss in excess of 20 million dollars then the software tool continues with decision block 410 the outcome of which depends on whether there is a potential for waste of human resources in excess of 100 staff years. If it is determined in decision block 410 that there is a potential for waste of human resources in excess of 100 staff years then the software tool branches to block 404 in which the consequence of failure is set to substantial. If on the other hand it is determined in block 410 that there is not a potential for waste of human resources in excess of 100 staff years, then the flow chart continues with decision block 412 the outcome of which depends on whether there is a potential for national adverse visibility. If it is determined in block 412 that there is a potential for national adverse visibility then the software tool branches to block 404 in which the consequence of failure is set to substantial. If on the other hand it is determined in block 412 that there is not a potential for national adverse visibility, then the software tool continues with decision block 414, the outcome of which depends on whether there is a potential for catastrophic failure. If it is determined in block 414 that there is a potential for catastrophic failure then the software tool branches to block 404 in which the consequence of failure is set to substantial. If on the other hand it is determined in block 414 that there is no potential for catastrophic failure, then it is concluded that the consequences of failure is not to be categorized as substantial, and the software tool continues as shown in FIG. 5 in order to determine the consequences of failure categorization for the proposed software development project.

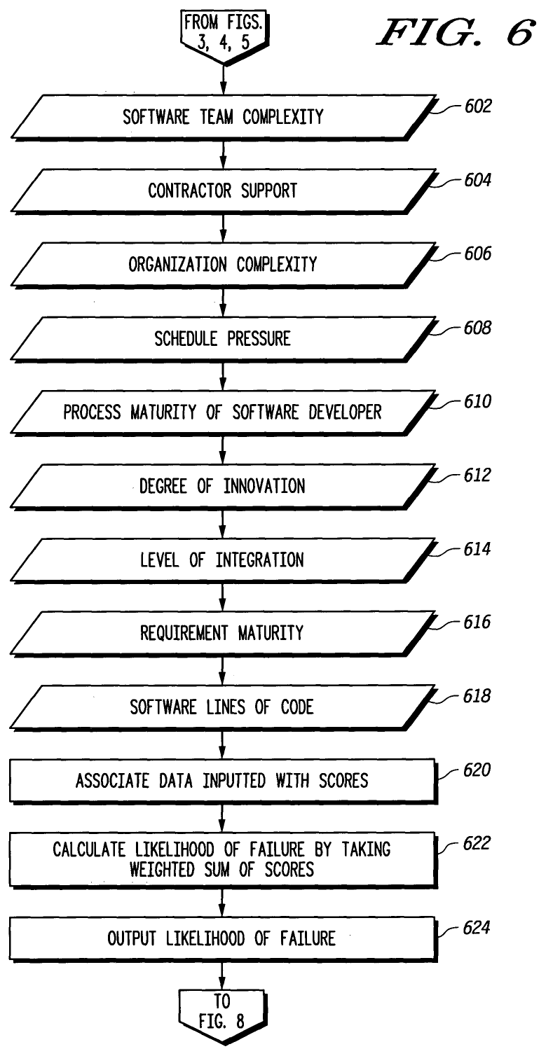

FIG. 5 includes several tests based on the user input provided in FIG. 1 which determine if the consequences of failure should be categorized as marginal or if not marginal then by default insignificant. Referring to FIG. 5 decision block 502 follows decision block 414, in the case that the outcome of block 414 is negative as to the potential for catastrophic failure The outcome of decision block 502 depends on whether there is a potential for partial mission failure. If it is determined in block 502 that there is a potential for partial mission failure, then the software tool branches to block 504 in which the consequence of failure is set to marginal and indication thereof output to the user. If on the other hand it is determine din block 502 that there is not a potential for partial mission failure then the software tool continues with decision block 506 the outcome of which depends on there is a potential for a work stoppage a particular center of location, or a potential for an agency wide inconvenience. Data used in blocks 406, and 506 is collected in block 116. If the outcome of block 506 is affirmative, then the software tool branches to block 504 in which the consequence of failure is set to marginal. If on the other hand the outcome of block 506 is negative, then the software tool branches to decision block 508 the outcome of which depends on whether there is a potential loss of equipment in excess of 2 million dollars. If it is determined in block 508 that there is a potential loss of equipment in excess of 2 million dollars then the software tool branches to block 504 in which the consequence of failure is set to marginal. If on the other hand it is determined in block 508 that there is not a potential for a loss of equipment in excess of 2 million dollars, then the software tool branches to decision block 510 the outcome of which depends on whether there is a potential for waste of human resources in excess of 20 staff years. If so then the software tool branches to block 504 in which the consequence of failure is set to marginal. If on the other hand it is determined in block 510 that there is not a potential for waste of human resources in excess of 20 staff years then, the software tool branches to decision block 512 the outcome of which depends on whether there is a possibility of internal (e.g., company wide) adverse visibility. If it is determined in decision block 512 that there is a potential for internal adverse visibility, then the software tool branches to block 504 in which the consequence of failure is set to marginal. If on the other hand there is not a potential for internal adverse visibility then, as a default, the software tool branches to block 514 in which the consequence of failure is set to insignificant. Thus tests performed in FIGS. 3-5, based on data read in FIG. 1, are used to categorize the consequences of failure of the software being developed. The tests performed in FIGS. 3-5 represent a first predetermined logic. The tests performed in FIGS. 3-5 effectively evaluate a Boolean expression for each consequence of failure categorization. For each of the grave, substantial, and marginal categorizations, a Boolean OR expression is effectively evaluated. Some of the operands of the Boolean OR expressions are particular answers of multiple choice questions, some are answers to yes/no questions. For example to for the consequences of failure to be set to grave the following Boolean expression must be true, (Potential for Loss of Life OR Potential for Loss of Equipment >100M OR Potential for Waste of Resources >200 Staff Years OR Potential for Adverse Visibility) For the insignificant categorization, a Boolean expression involving a leading NOT operator applied to an OR expression having all criteria which would lead to another categorization OR'ed together is effectively evaluated. In subsequent parts of software tool described below with reference to FIGS. 6-8 an assessment of the likelihood of failure is made.

FIG. 6 is a fifth part of the first flow chart of the software tool. FIG. 6 includes a sequence of data input blocks 602-618 for inputting data that is subsequently used to quantify the likelihood of failure of software to be developed by the software development project. The data input in blocks 602-618 is preferably input through the graphical user interface (GUI) 200 shown in FIGS. 2, 7, 14. The data input in blocks 602-618 preferably takes the form of answers to multiple choice questions. For each item of data the GUI the drop down select list 204 is preferably modified to contain a plurality of options from which the user selects an answer corresponding to the item of data. Referring to FIG. 6, in block 602 user input as to the complexity of a software development team that is to develop the software is read in. In block 604 user input as to involvement of contractors in the software development project is read in. In block 606 user input as to the complexity of the organization of the software development team is input. In block 608 user input as to schedule pressure for the project is read in. In block 610 user input as to as to the process maturity of the software development team is input. In block 612 user input as to the degree of innovation that characterizes the project is input. In block 614 user input as to the level of integration of the software with other software systems is input. In block 616 user input as to the maturity of the requirements for the software to be developed is read in, and in block 618 user input as to the estimated size of the software to be developed in terms of lines code is input.

Table I below lists, in the first column, the items of data input in blocks 602-618.

TABLE I

| Factors | | | | | | | |
|---|---|---|---|---|---|---|---|
| contributing | | | | | | | Likely- |
| to probability | | | | | | | hood of |
| of software | Un-weighted probability of failure score | | | | | Weighting | failure |
| failure | 1 | 2 | 4 | 8 | 16 | Factor | rating |
| Software | Up to 5 people | Up to 10 | Up to 20 | Up to 50 | More than 50 | X2 | |
| team | at one location | people at one | people at one | people at one | people at one | | |
| complexity | | location | location or 10 | location or 20 | location or 20 | | |
| | | | people with | people with | people with | | |
| | | | external | external | external | | |
| | | | support | support | support | | |
| Contractor | None | Contractor with | | Contractor with | Contractor with | X2 | |
| Support | | minor tasks | | major tasks | major tasks | | |
| | | | | | critical to | | |
| | | | | | project | | |
| | | | | | success | | |
| Organization | One location | Two locations | Multiple | Multiple | Multiple | X1 | |
| Complexity* | | but same | locations but | providers with | providers with | | |
| | | reporting chain | same reporting | prime sub | associate | | |
| | | | chain | relationship | relationship | | |
| Schedule | No deadline | | Deadline is | | Non-negotiable | X2 | |
| Pressure** | | | negotiable | | deadline | | |
| Process | Independent | Independent | Independent | CMM Level 1 | CMM Level 1 | X2 | |
| Maturity of | assessment of | assessment of | assessment of | with record of | or equivalent | | |
| Software | Capability | CMM Level 3 | CMM Level 2 | repeated | | | |
| Provider | Maturity Model | | | mission | | | |
| | (CMM) Level | | | success | | | |
| | 4, 5 | | | | | | |
| Degree of | Proven and | | Proven but | | Cutting edge | X1 | |
| Innovation | accepted | | new to the | | | | |
| | | | development | | | | |
| | | | organization | | | | |
| Level of | Simple-Stand | | | | Extensive | X2 | |
| Integration | alone | | | | Integration | | |
| | | | | | Required | | |
| Requirement | Wet defined | Well defined | | Preliminary | Changing, | X2 | |
| Maturity | objectives-No | objectives- | | objectives | ambiguous, or | | |
| | unknowns | Few unknowns | | | untestable | | |
| | | | | | objectives | | |
| Software | Less than 50K | | Over 500K | | Over 1000K | X2 | |
| Lines of | | | | | | | |
| Code*** | | | | | | | |
| Total | | | | | | | |

To the right of each item a plurality of alternative user inputs are shown. In blocks 602-618 the user preferably selects one of the plurality of different alternative user inputs from the drop down select list 204 of the GUI 200. In the second row of the table unweighted probability of failures scores corresponding to each column of alternative answers are shown. The scores range from one to sixteen as shown. In the last filled in column of the table a weighting fact for each item of data is shown. The weights are either one or two. The scores and weights shown in table are merely exemplary and are alternatively altered by an implementer of the software tool.

Referring again to FIG. 6, in block 620 each item of user input that is read in blocks 602-618 is associated with a corresponding score, (as appear in the first row of Table I). In block 622 a weighted sum of the scores for the data items input in blocks 602-618 is computed. The weighted sum uses the weights shown in Table I. The weighted sum is taken as the likelihood of failure. According to the values of scores, and the weights that appear in Table I, the likelihood of failure can take on values from sixteen to two hundred fifty six. In block 624 the likelihood of failure score is output.

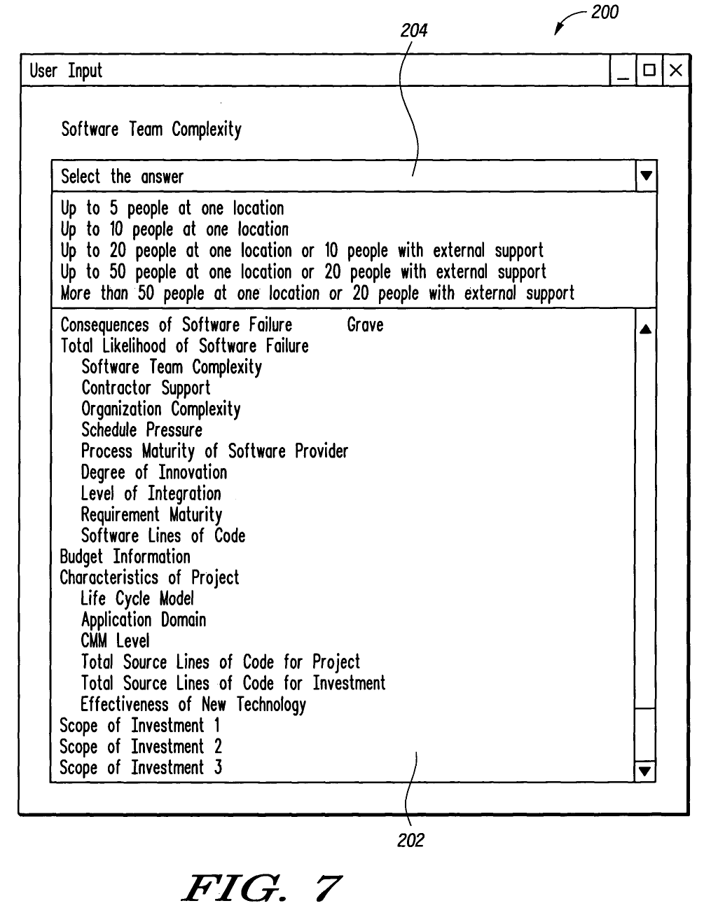

FIG. 7 is a second screen shot of the GUI 200 of the software tool. In the state shown in FIG. 7, the drop down select list 204 includes the alternative user inputs related to software team complexity.

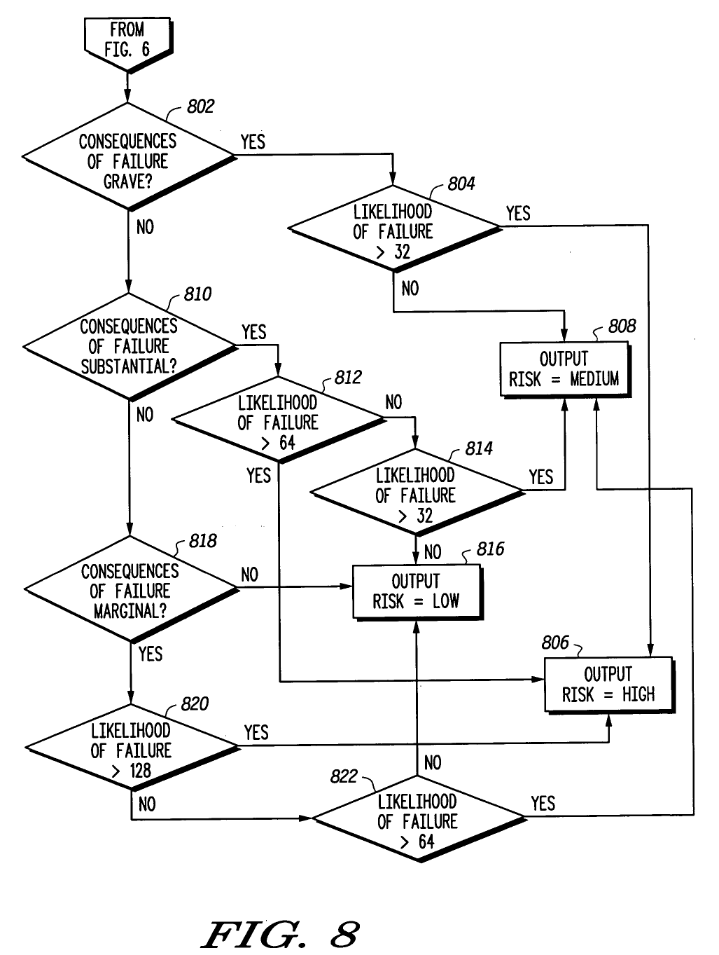

FIG. 8 is a sixth part of the first flow chart of the software tool. The part of the first flow chart shown in FIG. 8 is used to assess the overall risk associated with the software development project based on the consequences of failure preferably as determined as shown in FIGS. 1, 3-5, and based on the likelihood of failure preferably as determined as shown in FIG. 6. Referring to FIG. 8, block 802 is a decision block, the outcome of which depends on whether the consequences of failure are grave. If so, then the software tool branches to decision block 804 the outcome of which depends on whether the likelihood of failure is greater than thirty two. If the likelihood of failure is found in block 804 to be greater than thirty two then the software tool branches to block 806 in which the risk is set to high, and an indication thereof is output to the user. In the case of a high risk software development it is appropriate to apply verification and validation procedures at each stage of the software development project, and optionally a text message to that effect is output if block 806 is reached. If in block 804 it is found that the likelihood of failure is not greater than thirty two then the software tool branches to block 808 in which the risk is set to medium, and an indication that the risk is medium is output to the user. In the case of medium risk software development it is appropriate to apply verifications and validations procedures at at least some stages of software development, and optionally a text message to that effect is output if block 808 is reached. If in block 802 it is found that the consequences of failure are not grave, then the software tool branches to decision block 810 the outcome of which depends on whether the consequences of failure are substantial. If it is found in block 810 that the consequences of failure are substantial, then the software tool branches to decision block 812 the outcome of which depends on whether the likelihood of failure is greater than sixty four. If it is found that the likelihood of failure is greater than sixty four then the software tool branches to block 806 in which the risk is set to high and an indication thereof is output to the user. If on the other hand it is found in decision block 812 that the likelihood of failure is not greater than sixty four, then the software tool branches to decision block 814 the outcome of which depends on whether the likelihood of failure is greater than thirty-two. If it is found in decision block 814 that the likelihood of failure is greater than thirty two then the software tool branches to block 808 in which the risk is set to medium and an indication thereof is output to the user. If on the other hand it is found in block 814 that the likelihood of failure is not greater than thirty two then the software tool branches to block 816 in which the risk is set to low and an indication thereof is output to the user. If in block 810 it is found that the consequences of failure are not substantial, then the software tool branches to decision block 818 the outcome of which depends on whether the consequences of failure are marginal. If it is found in decision block 818 that the consequences of failure are not marginal then the software tool branches to block 816 in which the risk is set to low and an indication thereof is output to the user. In the case of low risk software development projects it may be unnecessary to apply verification and validation procedures, and optionally a text message to that effect is output if block 816 is reached. If on the other hand it is found in decision block 818 that the consequences of failure are marginal, then the software tool branches to decision block 820 the outcome of which depends on whether the likelihood of failure exceeds one hundred twenty eight. If in block 820 it is found that the likelihood of failure exceeds one hundred twenty eight, then software tool branches to block 806 in which the risk is set to high and an indication thereof is output to the user. If on the other hand it is found in block 820 that the likelihood of failure does not exceed a one-hundred twenty eight, then the software tool branches to decision block 822, the outcome of which depends on whether the likelihood of failure exceeds sixty four. If it is found in block 822 that the likelihood of failure does not exceed sixty four, then the software tool branches to block 816 in which the risk is set to low, and an indication thereof is output to the user. If on the other hand the it is found in decision block 822 that the likelihood of failure exceeds sixty four then the software tool branches to block 808 in which the risk is set to medium and an indication thereof is output to the user. Note that the thresholds of thirty two, sixty four, and one hundred twenty eight that are used in FIG. 8 are merely exemplary. The interconnected blocks of FIG. 8 represent a second predetermined logic. The decision blocks 802, 804, 810, 812, 814, 818, 820, 822 shown in FIG. 8 represent Boolean valued statements including inequalities including the likelihood of failure and the aforementioned thresholds.

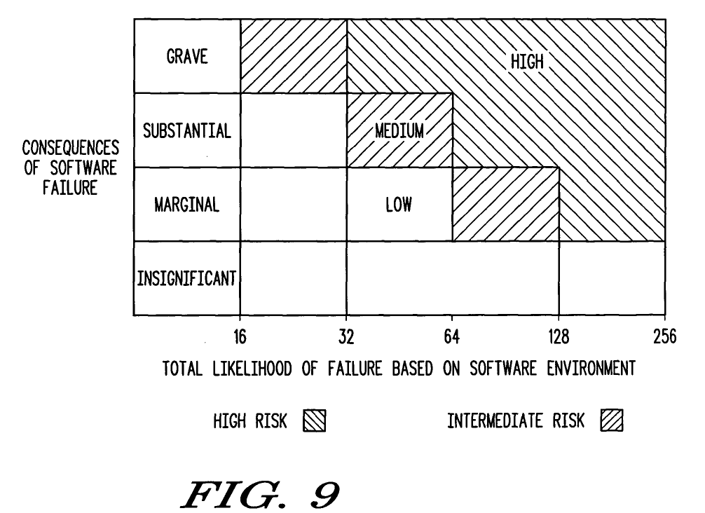

FIG. 9 is a chart illustrating the dependence of software project risk, on the likelihood of failure and the consequences of failure. FIG. 9 reflects the classification of risk based on the likelihood of failure and the consequences of failure that is conducted by the part of the software tool illustrated in FIG. 8. The chart includes four rows one for each category of the consequences of failure. Numerical values of the likelihood of failure ranging from 16 to 256 are marked off along the bottom of the chart. Regions of the chart are color coded to indicate the level of risk. White areas correspond to low risk, light gray areas correspond to medium risk, and dark gray areas correspond to high risk. As seen in FIG. 9 the risk associated with a software development project is dependent on the consequences of failure of the project, and the likelihood of failure of the project.

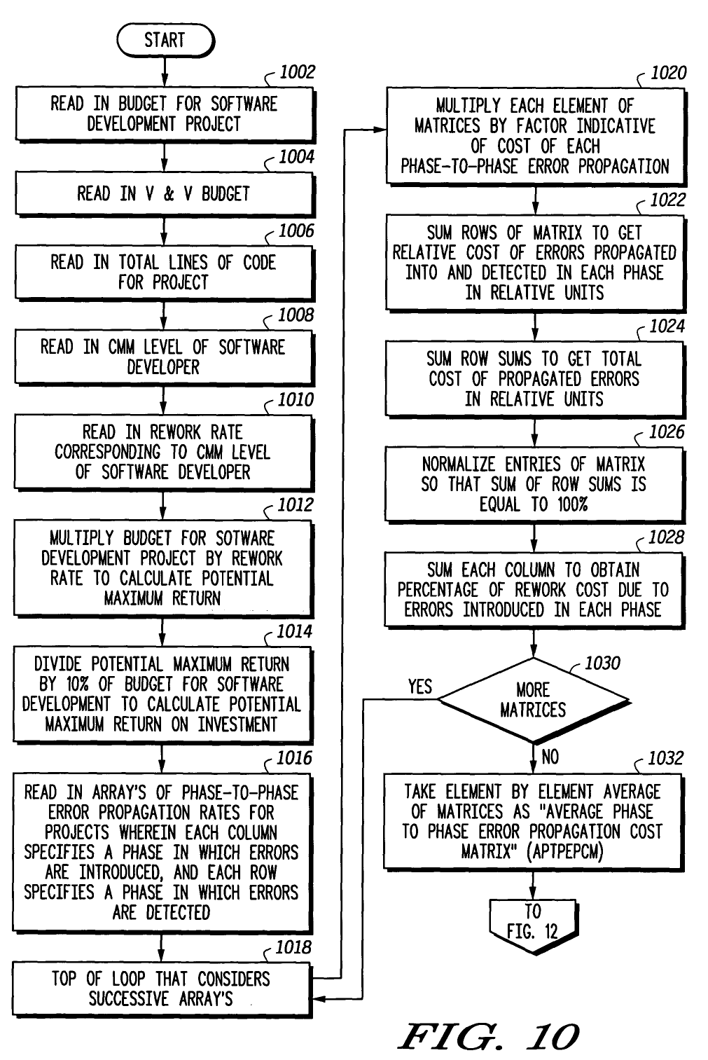

FIG. 10 is a first part of a second flow chart of a second part of a software tool for assessing efficacy of investments in software verification and validation (V&V) technologies at various phases of a software development project. Referring to FIG. 10, in block 1002 a budget for a software development project is read in. In block 1004 a total amount to be spent on V&V activities is read in. In block 1006 an estimated total number of lines of code for the software development project is read in. In block 1008 a capability maturity model (CMM) level for the software development group that is to undertake the software development project is read in. The CMM level is a measure of software development proficiency that is determined by a methodology established by the Software Engineering Institute at Carnegie Mellon University. The characterization of software development organizations is described in M. C. Paulk et al, “Capability Maturity Model^{SM} for Software, Version 1.1, February 1993, published by the Software Engineering Institute at Carnegie Mellon University. Note that in the preferred case that the second part of the software tool is implemented in conjunction with the first part of the software development tool shown in FIGS. 1, 3-6, 8, blocks 1006, and 1008 will be redundant as they will already have been performed in blocks 618, and 610 (FIG. 6) respectively.

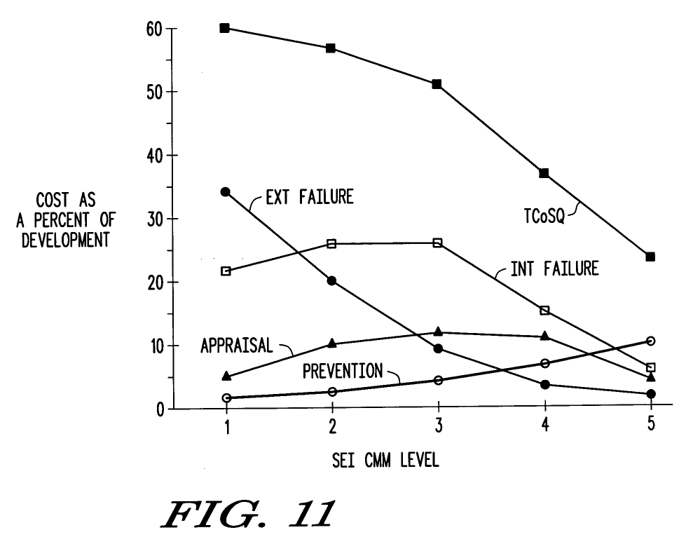

In block 1010 the rework rate corresponding to the CMM level of the software developer is read in. The rework rate is preferably derived from a model of software quality known as the Knox model, and described in Knox, S. T., “Modeling the Cost of Software Quality”, Digital Technical Journal, Vol. 5, No. 4, 1993, pp 9-16. The Knox model segregates the cost of quality into the costs due to lack of quality, and the costs of achieving quality. The cost of achieving quality includes the cost of appraisal, and the cost of prevention. The cost of appraisal covers efforts aimed at discovering the condition of the product, such as testing, and product quality audits. The cost of prevention covers process improvement efforts, metrics collection and analysis and Software Quality Assurance (SQA) administration. The costs due to lack of quality includes costs associated with failures discovered internally, and failures discovered externally. The costs associated with internally discovered failures include the cost for defect management, rework, and retesting. The costs associated with externally discovered failures include the costs of technical support, complaint investigation, and defect notification. The Knox model predicts the foregoing costs as a function of the CMM level of the software development organization. FIG. 11 is a graph representation of the Knox model of the cost of software quality. The abscissa is marked off with CMM levels, and the ordinate shows cost as a percentage of the software development project budget. In the graph the cost associated with prevention, appraisal, internally discovered failures, and externally discovered failures, along with the total of the foregoing-the total cost of software quality are plotted as a function of CMM level. The rework rate is taken as the sum of costs of internally and externally discovered errors. Thus, reading from the graph, the rework rate is 55% for CMM level 1, 45% for CMM level 2, 35% for CMM level 3, 20% for CMM level 4, and 6% for CMM level 5. The foregoing values are preferably included in data, which the software tool accesses in block 1010.

In block 1012 the budget for the software development project (read in block 1002) is multiplied by the rework rate (read in block 1010) to obtain the potential maximum return for the project. The potential maximum return is the amount that could ideally be saved if all rework were eliminated.

In block 1014 the potential maximum return, calculated in the preceding block, is divided by ten percent of the software development budget in order to obtain a potential maximum return on investment. As described further below ten percent of the software development budget is considered an amount necessary to obtain the full effect of software verification and validation activities i.e. the elimination of rework.

In block 1016 one or more matrices of phase-to-phase error propagation rates are read in. Table II below includes exemplary phase-to-phase error propagation rates such as included in the matrices read in block 1016.

TABLE II

| Phase- | | | | | |
|---|---|---|---|---|---|
| Introduced → | | | | | |
| Phase | | | | | |
| Detected | Require- | | Program- | | Deploy- |
| ↓ | ments | Design | ming | Integration | ment |
| Requirements | — | — | — | — | — |
| Design | 49 | 681 | — | — | — |
| Programming | 39 | 113 | 2,004 | — | — |
| Integration | 26 | 49 | 418 | 5 | — |
| Deployment | 8 | 16 | 56 | — | 1 |
| Total | 122 | 859 | 2,478 | 5 | 1 |

In the table each of the columns and each of the rows (except the last row) is associated with one of five phases of a software development project: requirements, design, programming, integration, and deployment. The column of an entry specifies a phase of a software development project in which errors are introduced, and the row specifies a phase in which errors are discovered. Thus, each entry of the table specifies a number of errors that were introduced in a phase corresponding to the column of the entry and discovered in a phase corresponding to a row of the entry. The entries of Table II make up an matrix of the type that is read in block 1016. In subsequent processing elements of the matrix that correspond to errors that are discovered in the same phase as they are introduced are preferably ignored, in as much as the succeeding computations are preferably concerned with rework not in phase correction.

Block 1018 is the top of a loop that processes successive matrices of phase-to-phase error propagation values. In block 1020 each element of each matrix is multiplied by a cost factor associated with propagation of an error between phases to which the matrix element corresponds. According to the preferred embodiment of the invention, for each phase that an error propagates into before being discovered, the cost to correct the error is considered to increase by a factor of ten. Thus, for example, the rework cost associated with errors that are introduced in the requirements phase, and are caught in the immediately succeeding design phase are given cost weight (factor) of ten, whereas errors that are introduced in the requirements phase but not caught until the programming phase, two phases later, are given a cost weight of one-hundred. It is appropriate to increase relative rework cost as errors propagate through more phases, because more work that will need to be redone will have been based on the errors. Applying the foregoing factor of ten rule to Table II yields Table III below, in which the phase to phase error propagation values are multiplied by correction cost weights.

TABLE III

| Phase- | | | | | | Total Rework |
|---|---|---|---|---|---|---|
| Introduced → | | | | | | Cost (effort |
| Phase Detected | | | | | | units) in each |
| ↓ | Requirements | Design | Programming | Integration | Deployment | Phase |
| Requirements | — | — | — | — | — | — |
| Design | 49 * 10 | | — | — | — | 490 |
| Programming | 39 * 100 | 113 * 10 | | — | — | 5,030 |
| Integration | 26 * 1000 | 49 * 100 | 418 * 10 | 0 | — | 35,080 |
| Deployment | 8 * 10000 | 16 * 1000 | 56 * 100 | — | | 101,600 |
| Total | — | — | — | — | — | 142,170 |

Each entry of Table III (other than the totals) represents the relative cost associated with errors that are introduced in a phase corresponding to the column of the entry and detected in a phase corresponding to the row of the entry. Relative costs in Table III are not normalized and not in currency units.

Note alternatively rather than simply increasing the relative cost by a factor of ten for each phase into which an error propagates, a different factor can be used, or an matrix of factors including one for each specific phase-to-phase error propagation entry is used. Such factors can be chosen based on empirical data as to the cost associated with error propagation.

In block 1022 the rows of the matrix (e.g., Table III) are summed to get a total for the relative cost of errors propagated into and detected in each phase. The totals appear as the last column in Table III. In block 1024, the row sums computed in block 1022 are summed to get a total relative cost of propagated errors that is to be used for the purpose of normalization. The sum of the row sum appears at the lower right corner of Table III. In block 1024 the entries of the table are normalized so that the sum of the row sums is equal to 100%. The result of block 1024 is referred to herein below as a Phase To Phase Error Propagation Cost Matrix. Table IV below shows the result after normalization.

TABLE IV

| Phase- | | | | | | Total Rework |
|---|---|---|---|---|---|---|
| Introduced → | | | | | | Cost (effort |
| Phase Detected | | | | | | units) in each |
| ↓ | Requirements | Design | Programming | Integration | Deployment | Phase |
| Requirements | — | — | — | — | — | — |
| Design | 0.34% | — | — | — | — | 0.34% |
| Programming | 2.74% | 0.79% | — | — | — | 3.54% |
| Integration | 18.28% | 3.45% | 2.94% | — | — | 24.67% |
| Deployment | 56.26% | 11.25% | 3.94% | — | — | 71.45% |
| % of Rework | 77.63% | 15.49% | 6.88% | — | — | 100.00% |
| costs Due to | | | | | | |
| Each Phase | | | | | | |

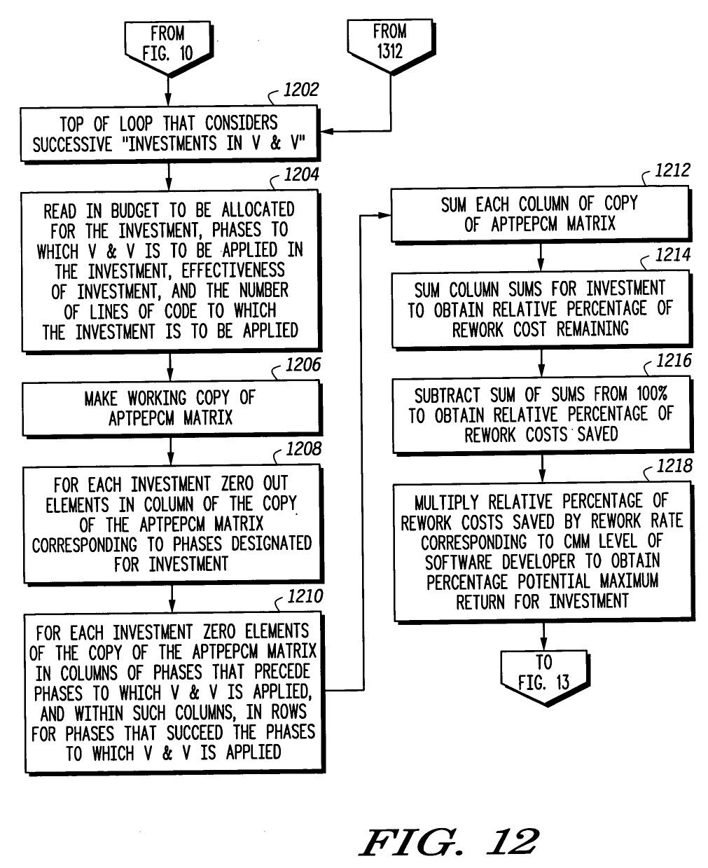

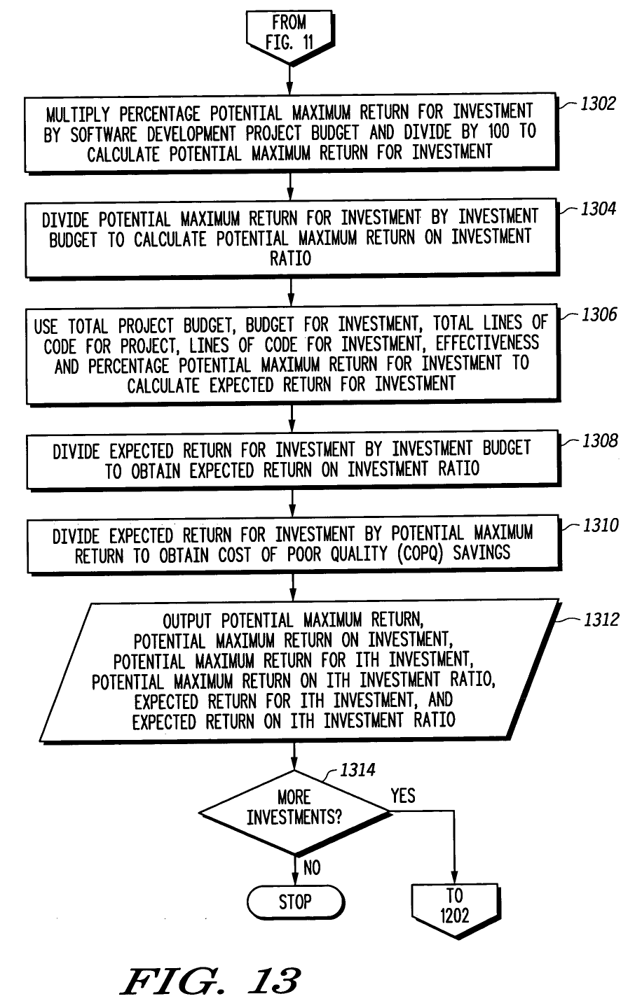

In block 1028 each column is summed to obtain a percentage of rework cost due to errors introduced in each phase. The column sums appear at the bottom of Table IV. Block 1030 is a decision block the outcome of which depends on whether there are further matrices of phase to phase error propagation rates to be processed. If so then the software tool loops back to block 1018 to process another matrix. If, on the other hand, all the matrices read in block 1016 have been processed, the software tool continues with block 1032 in which an element by element average of the, matrices produced in one or more executions of loop started in block 1018, is taken. The average matrix is hereinafter referred to as the Average Phase To Phase Error Propagation Cost Matrix APTPEPCM. Taking averages serves to make the resulting matrix more likely to be representative of the break down of costs associated with phase-to-phase error propagation, that typically characterizes software development projects. Note that first part of the second flow chart that is shown in FIG. 10 need only be executed once, and the result obtained in block 1032 stored for future use in executing the second and third parts of the second flow chart shown in FIGS. 12 and 13 respectively. Table V includes an APTPEPCM matrix that is based on six data sets collected from large industrial software development projects.

TABLE V

| Phase- | | | | | | Total Rework |
|---|---|---|---|---|---|---|
| Introduced → | | | | | | Cost (effort |
| Phase Detected | | | | | | units) in each |
| ↓ | Requirements | Design | Programming | Integration | Deployment | Phase |
| Requirements | 0.00% | 0.00% | 0.00% | 0.00% | 0.00% | 0.00% |
| Design | 5.54% | 0.00% | 0.00% | 0.00% | 0.00% | 5.54% |
| Programming | 4.27% | 11.39% | 0.00% | 0.00% | 0.00% | 15.66% |
| Integration | 10.77% | 16.55% | 24.55% | 0.00% | 0.00% | 51.87% |
| Deployment | 17.20% | 6.57% | 3.15% | 0.01% | 0.00% | 26.93% |
| % of Rework | 37.78% | 34.51% | 27.70% | 0.01% | 0.00% | 100.00% |
| Costs Due to | | | | | | |
| Each Phase | | | | | | |

FIG. 12 is a second part of the second flow chart. Block 1202 follows block 1032 of shown in FIG. 10. Block 1202 is the top of loop that considers successive investments in V&V to be applied to the software development project. In block 1204 the total V&V budget to be allocated for the investment, phases to which the V&V is to be applied per the investment, a quantification of effectiveness for the investment expressed as a percentage, and the estimated number of lines of code to which the investment is to be applied are read in. The foregoing are preferably read in through the GUI 200. In block 1206 a working copy of the APTPEPCM matrix is made. Alternatively, the results of operations using elements of the APTPEPCM matrix are stored and manipulated using other variable names. In block 1208 for each investment elements in columns of the copy of the APTPEPCM matrix corresponding to phases to which V&V is applied per the investment are zeroed out. The latter operation is consistent with the assumption that V&V applied at a particular phase will eliminate the introduction of errors in that phase. In block 1210 elements of the copy of the APTPEPCM matrix in columns of phases that precede phases to which V&V is applied, and within such columns, in rows for phases that succeed the phases to which V&V is applied are zeroed. The foregoing operation reflects that V&V applied at a particular phase is assumed to eliminate at the phase at which V&V is applied, errors that are introduced in phases preceding the phases at which V&V is applied such that those errors will not propagate beyond the phases at which V&V is applied. By way of illustration Table VI below is a copy of the APTPEPCM matrix which has been modified per blocks 1208, 1210 in the case of an investment that is applied only at the design phase.

TABLE VI

| Phase- | | | | | | Total Rework |
|---|---|---|---|---|---|---|
| Introduced → | | | | | | Cost (effort |
| Phase Detected | | | | | | units) in each |
| ↓ | Requirements | Design | Programming | Integration | Deployment | Phase |
| Requirements | 0.00% | 0.00% | 0.00% | 0.00% | 0.00% | 0.00% |
| Design | 5.54% | 0.00% | 0.00% | 0.00% | 0.00% | 5.54% |
| Programming | 0.00% | 0.00% | 0.00% | 0.00% | 0.00% | 15.66% |
| Integration | 0.00% | 0.00% | 24.55% | 0.00% | 0.00% | 51.87% |
| Deployment | 0.00% | 0.00% | 3.15% | 0.01% | 0.00% | 26.93% |
| % of Rework | 5.54% | 0.00% | 27.70% | 0.01% | 0.00% | 33.25% |
| Costs Due to | | | | | | |
| Each Phase | | | | | | |

Per block 1208 the elements in the design phase column have been zeroed out. Per block 1210 the elements in the requirements phase column below the design row have been zeroed out.

In block 1212 each column of the APTPEPCM matrix modified per the preceding to blocks 1208, 1210 is summed. The resulting column sums are shown in Table VI. In block 1214 the column sums are summed. The sum of the column sums is shown in the lower right box of Table VI. The sum of the column sums represents a relative percentage of rework costs remaining after application of V&V investments. In block 1216 the sum of the column sums is subtracted from 100% to obtain the a relative percentage of rework costs saved by the investment corresponding to the current iteration of the loop begun in block 1202. In this context 100% represents the cost of rework if no V&V is applied. In block 1218 the relative percentage of rework cost saved is multiplied by the rework rate corresponding to the CMM level of the software developer (read in block 1010) to obtain a percentage potential maximum return for the investment.

The second flow chart continues on FIG. 13 with block 1302. In block 1302 the percentage potential maximum return for the investment, calculated in block 1218 is multiplied by the software development project budget and divided by 100 to obtain an estimated potential maximum return for the investment. The estimated potential maximum return for an ith investment (corresponding to the current iteration of the loop begun at block 1202) is given by:

PMRi=PPMRi*TB/100 EQU. 1

where,

TB is the total budget for the software development project; and

PPMRi is the percentage potential maximum return for an ith investment.

In block 1304 the potential maximum return for the investment is divided by the investment budget to obtain a potential maximum return on investment ratio. The potential maximum return on investment ratio for the ith investment is given by:

PMRRi=PPMRi*TB/(100*IBi) EQU2:

where, IBi is the budget for an ith investment in V&V activities, and other variables are defined above.

In block 1306 the total project budget (read in block 1002), the budget for the investment (read in 1202), the estimated total lines of code for the project (read in 1006), the estimated lines of code for the investment (read in 1202), the effectiveness of the budget (read in 1202) and the percentage potential maximum return for the investment (calculated in 1216) are used as inputs of an expected return model to calculate the expected return for the investment. The expected return is preferably given by the following piecewise defined function:

$$\begin{matrix}E . R . = TB * ( \frac{PPMRi}{100} ) * ( \frac{10 * IBi}{TB} ) * ( \frac{ILCi}{TLC} ) * ( \frac{eff}{100} ) \\ for IBi < TB / 10 \\ = TB * ( \frac{PPMRi}{100} ) * ( \frac{ILCi}{TLC} ) * ( \frac{eff}{100} ) \\ for IBi > TB / 10\end{matrix} \qquad EQU 3$$

where,

ILCi is the estimated lines of code to which the investment is applied;

TLC is the estimated total number of lines of code for the project;

eff is the effectiveness of the investment and

other variables are defined above.

Note that according to EQU. 3 the expected return scales linearly with the budget for the ith investment up to the point where the budget for the ith investment is equal to one tenth of the total budget for the software development project. According to this model further increase in the ith investment budget do not increase the expected return. Generally, it can be said of the expected return model represent in EQU. 3 that it exhibits a monotonic non decreasing dependence on the investment budget IBi, and a monotonic increasing dependence on Ibi up to a value of IBi of one tenth the software development budget. Alternatively rather than setting the limit for the scaling of the expected return, with investment budget at one-tenth the total budget another fraction is chosen. The value of one-tenth is preferred as it is consistent with industry guidelines as to how much investment should be made in V&V activities. Note that the first expression of EQU. 3 which is applicable in the case that IBi<TB/10 can be simplified to:

$$E . R . = ( \frac{PPMRi}{10} ) * IBi * ( \frac{ILCi}{TLC} ) * ( \frac{eff}{100} ) \\ for IBi < TB / 10 \qquad EQU . 4$$

In block 1308 the expected return for the ith investment is divided by the budget for the ith investment to obtain the expected return on investment ratio for the ith investment which accordingly is given by:

E.R.Ri=E.R./IBi EQU. 5

In block 1310 the expected return for the ith investment is divided by the potential maximum return (calculated in block 1012) to obtain a cost of poor quality savings figure.

In block 1312 the potential maximum return for the ith investment, the potential maximum return on investment ration for the ith investment, the expected return for the ith investment, and expected return on investment ratio for the ith investment are output through the GUI 200.

In block 1314 it is determined if there are more investments to be processed. If so then the software tool loops back to block 1202 to consider another investment.

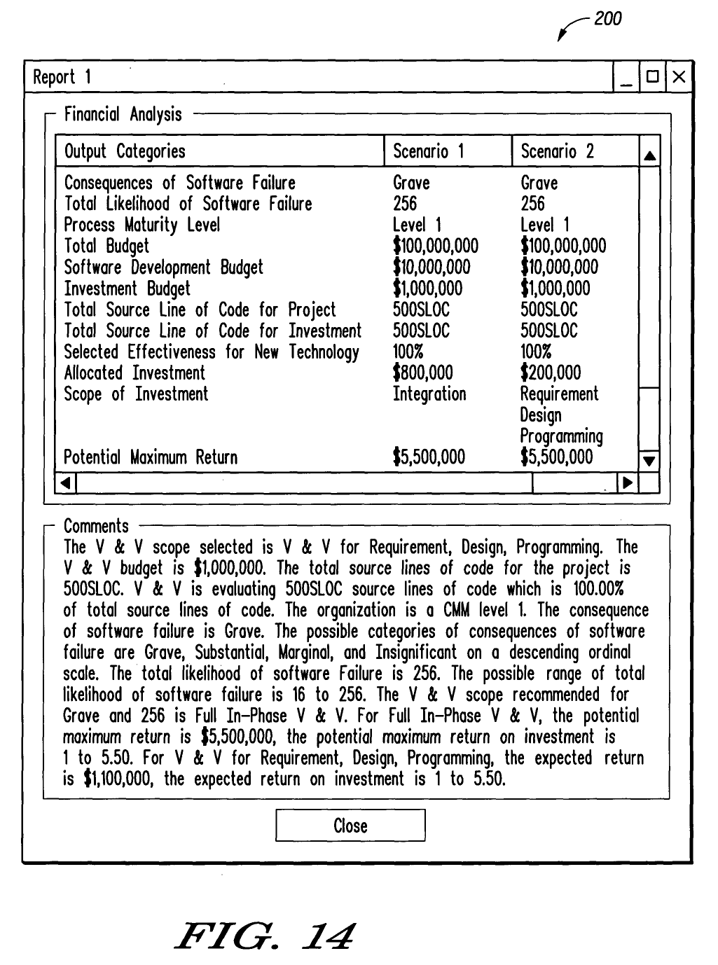

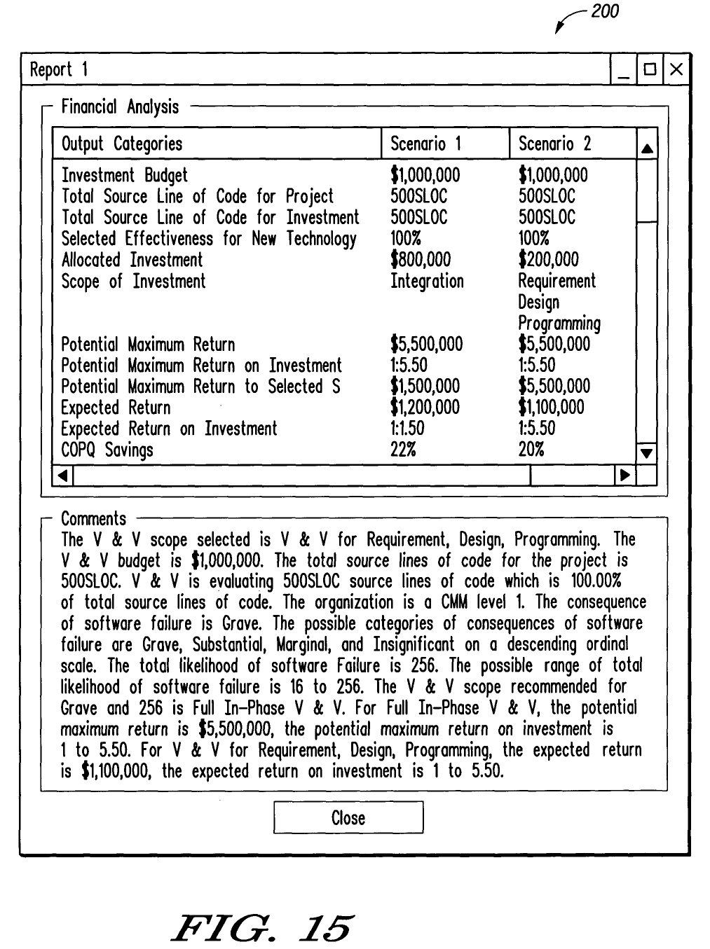

FIGS. 14-15 are third and fourth screen shots of the graphical user interface, that show an output report. The output report echoes some of the input data related to each investment, and also includes the data output in block 1312. As shown in FIGS. 14-15 information is also formatted into a paragraph and presented in paragraph form.

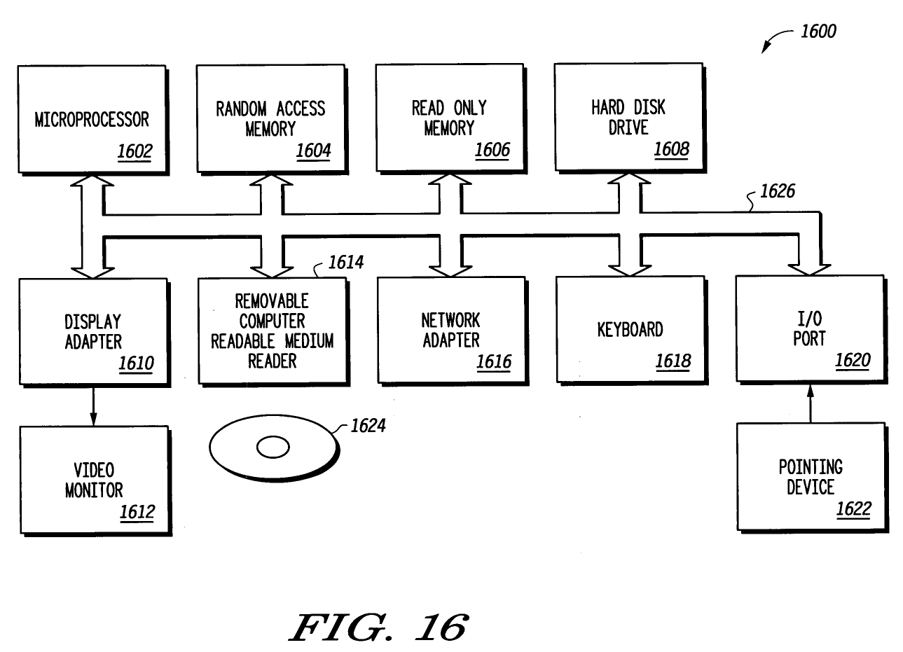

FIG. 16 is a block diagram of a computer 1600 used to execute the algorithms shown in FIGS. 1, 3-6, 8, 10, 12, 13 according to the preferred embodiment of the invention. The computer 1600 comprises a microprocessor 1602, Random Access Memory (RAM) 1604, Read Only Memory (ROM) 1606, hard disk drive 1608, display adopter 1610, e.g., a video card, a removable computer readable medium reader 1614, a network adapter 1616, keyboard, and I/O port 1620 communicatively coupled through a digital signal bus 1626. A video monitor 1612 is electrically coupled to the display adapter 1610 for receiving a video signal. A pointing device 1622, preferably a mouse, is electrically coupled to the I/O port 1620 for receiving electrical signals generated by user operation of the pointing device 1622. The computer readable medium reader 1614 preferably comprises a Compact Disk (CD) drive. A computer readable medium 1624 that includes software embodying the algorithms described above with reference to FIGS. 1, 3-6, 8, 10, 12, 13 is provided. The software included on the computer readable medium 1624 is loaded through the removable computer readable medium reader 1614 in order to configure the computer 1600 to carry out processes of the current invention that are described above with reference to flow diagrams. The software on the computer readable medium 1624 in combination with the computer 1600 make up a system for assessing the risk involved in software development projects, and modeling the efficacy of various verification and validation investments. The computer 1600 may for example comprise a personal computer or a work station computer.

As will be apparent to those of ordinary skill in the pertinent arts, the invention may be implemented in hardware, software, or a combination thereof. Programs embodying the invention or portions thereof may be stored on a variety of types of computer readable media including optical disks, hard disk drives, tapes, programmable read only memory chips. Network circuits may also serve temporarily as computer readable media from which programs taught by the present invention are read.

Although particular forms of flow charts are presented above for the purpose of elucidating aspects of the invention, the actual logical flow, of programs is dependent on the programming language in which the programs are written, and the style of the individual programmer(s) writing the programs. The structure of programs that implement the teachings of the present invention can be varied from a logical structure that most closely tracks the flow charts shown in the FIGs. without departing from the spirit and scope of the invention as set forth in the appended claims.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A computer readable medium including programming instructions for assessing the risk associated with software developed in a software development project, comprising programming instructions for:
reading in a first plurality of a user's answers to a first plurality of questions concerning the consequences of software failure;
applying a first predetermined logic to the first plurality of user's answers in order to determine a category of consequences of failure associated with software development project; and
outputting information to the user based on the category.

2. The computer readable medium according to claim 1 wherein the programming instructions for reading in the first plurality of the user's answers comprise programming instructions for:
reading in a plurality of answers to yes/no questions.

3. The computer readable medium according to claim 2 wherein the programming instructions for applying a first predetermined logic comprise programming instructions for:
for a possible category of consequences of failure testing if the answer to one or more questions is affirmative.

4. The computer readable medium according to claim 1 wherein the programming instructions for reading in the first plurality of the user's answers comprise programming instructions for:
reading in an answer to a multiple choice question.

5. The computer readable medium according to claim 4 wherein the programming instructions for applying a first predetermined logic comprise programming instructions for:
for a possible category of consequences of failure testing if a particular answer to the multiple choice question has been given.

6. The computer readable medium according to claim 4 wherein the programming instructions for reading in the first plurality of the user's answers comprise programming instructions for:
reading in a plurality of answers to yes/no questions.

7. The computer readable medium according to claim 1 wherein the programming instructions for applying a first predetermined logic comprise programming instructions for:
for a possible category of consequences of failure effectively evaluating a Boolean OR expression involving at least a subset of the first plurality of answers.

8. The computer readable medium according to claim 7 wherein the programming instructions for:
reading in the first plurality of the user's answers comprise programming instructions for:
reading in an answer to a yes/no questions; and
reading in an answer to a multiple choice question; and
the programming instructions for evaluating the Boolean OR expression comprise programming instructions for:
effectively evaluating a Boolean OR expression that includes the answer to the yes/no question, and the answer to the multiple choice question.

9. The computer readable medium according to claim 1 wherein the programming instructions for reading in the first plurality of the user's answers to a plurality of questions comprise programming instructions for:
reading in answers to one or more questions selected from the group consisting of:
is there a potential for loss of life;
is there a potential for serious injury;
is there a potential for partial mission failure;
is there a potential for catastrophic mission failure;
a multiple choice question as to the amount of potential loss of equipment;
a multiple choice question as to the amount of potential for waste of human resources investment;
a multiple choice question as to the potential for adverse visibility; and
a multiple choice question as to the potential effect on routine operations.

10. The computer readable medium according to claim 1 further comprising programming instructions for:
reading in a second plurality of answers to a second plurality of questions concerning a software development team for the software development project;
associating each of the second plurality of user's answers with a score;
calculating a likelihood of failure by performing a mathematical operation on the scores associated with the second plurality of answers; and
outputting information based on the likelihood of failure.

11. The computer readable medium according to claim 10 wherein the programming instructions for performing the mathematical operation comprise programming instructions for:
taking a weighted sum of the scores.

12. The computer readable medium according to claim 10 wherein the programming instructions for reading in the second plurality of answers comprise programming instructions for reading in a plurality of answers to multiple choice questions.

13. The computer readable medium according to claim 10 wherein the programming instructions for reading in the second plurality of answers comprise programming instructions for reading in one more answers to questions selected from the group consisting of:
a question regarding software team complexity;
a question regarding contractor support;
a question regarding organizational complexity;
a question regarding schedule pressure;
a question regarding process maturity of software development team;
a question regarding degree of innovation;
a question regarding level of integration;
a question regarding requirements maturity; and
a question regarding software lines of code.

14. The computer readable medium according to claim 10 further comprising programming instructions for:
applying a second predetermined logic to the category consequences of failure, and the likelihood of failure in order to determine an overall risk associated with the software development project.

15. The computer readable medium according to claim 14 wherein the programming instructions for applying a second predetermined logic comprise programming instructions for:
for one or more categories of consequences of failure, evaluating one or more Boolean values of one or more inequalities involving the likelihood of failure, and based on outcomes of the evaluating the one or more Boolean values, assigning a overall risk;
outputting information based on the overall risk.

16. A computer readable medium including programming instructions for assessing the likelihood of failure of a software development project including programming instructions for:
reading in a plurality of answers to a plurality of questions concerning a software development team for the software development project;
associating each of the plurality of user's answers with a score;
calculating a likelihood of failure by performing a mathematical operation on the scores associated with the plurality of answers; and
outputting the likelihood of failure.

17. The computer readable medium according to claim 16 wherein the programming instructions for performing a mathematical operation comprise programming instructions for:
taking a weighted sum of the scores.

18. The computer readable medium according to claim 16 wherein the programming instructions for reading in a plurality of answers comprises programming instructions for reading in a plurality of answers to multiple choice questions.

19. The computer readable medium according to claim 18 wherein the programming instructions for reading in a plurality of answers comprise programming instructions for reading in one more answers to questions selected from the group consisting of:
a question regarding software team complexity;
a question regarding contractor support;
a question regarding organizational complexity;
a question regarding schedule pressure;
a question regarding process maturity of software development team;
a question regarding degree of innovation;
a question regarding level of integration;
a question regarding requirements maturity; and
a question regarding software lines of code.

20. A computer readable medium comprising programming instructions for estimating the efficacy of investments in software verification and validation activities comprising programming instructions for:
reading a phase to phase error propagation cost matrix;
reading in specifications of a software verification and validation investment including:
a specification of phases to which software verification and validation methods are to be applied per the investment;
zeroing out elements of the cost matrix that correspond to errors introduced in phases in the specification of phases;
zeroing out elements of the cost matrix that correspond to errors introduced in phases preceding phases in the specification of phases, and discovered in phases succeeding the phases in the specification of phases;
summing elements of the matrix to obtain a sum;
subtracting the sum from a value representing full cost of rework to obtain a measure of rework costs saved;
outputting a first value that is dependent on the measure of rework costs saved.

21. The computer readable medium according to claim 20 further comprising programming instructions for:
reading in a rework rate for a software development team;
computing the first value that is dependent on the measure of rework costs saved from the measure of rework costs saved by a process including:
multiplying the measure of rework costs saved by the rework rate to obtain a percentage potential maximum return for the investment.

22. The computer readable medium according to claim 21 wherein the programming instructions for multiplying the measure of rework costs saved by the rework rate comprise programming instructions for:
multiplying the measure of rework costs saved by a rework rate that is related through a model to a measure of process maturity of a software development team.

23. The computer readable medium according to claim 22 further comprising programming instructions for:
reading in a software development budget;
multiplying the potential maximum return for the investment by the software development budget to obtain a potential maximum return for the investment.
outputting the potential maximum return for the investment.

24. The computer readable medium according to claim 21 further comprising programming instructions for:
using the first value in an expected return model to compute expected return; and
outputting information based on the expected return

25. The computer readable medium according to claim 24 wherein the programming instructions for:
reading in specifications of the software verification and validation investment comprise programming instructions for:
reading in a budget amount allocated for the software verification and validation investment; and
the expected return model is dependent on the budget amount allocated for the software verification and validation investment and has a monotonic non-decreasing dependence on the budget amount allocated for the software verification and validation investment.

26. The computer readable medium according to claim 24 wherein:
the expected return model has a monotonic increasing dependence on the budget amount allocated for the software verification and validation investment for values of the budget amount allocated for the software verification and validation investment up to about one-tenth of a software development project budget.

27. The computer readable medium according to claim 24 further comprising programming instructions for:
dividing the expected return by the budget amount allocated for the software verification and validation investment to obtain an expected return on investment
